(19) United States
(12) Patent Application Publication
(10) Pub. No.: US 2026/0090538 A1
(43) Pub. Date: Apr. 2, 2026

(54) SPINNING WING DECOYS AND METHODS FOR USING THEM

(71) Applicant: Huntwise, Inc., Monroe, LA (US)

(72) Inventor: Terry DENMON, Monroe, LA (US)

(73) Assignee: Huntwise, Inc., Monroe, LA (US)

(21) Appl. No.: 19/345,155

(22) Filed: Sep. 30, 2025

Related U.S. Application Data
(60) Provisional application No. 63/702,070, filed on Oct. 1, 2024.

(51) Int. Cl. A01M 31/06

(52) U.S. Cl. CPC A01M 31/06

(57) ABSTRACT

Disclosed herein are spinning wing decoys for hunting, birdwatching, photographing, and other outdoor activities. In a specific embodiment, the spinning wing decoy includes: an axle, axle hub, drive shaft, motor, motor housing, motor door, retainer ring, remote controller, receiver, transmitter, computer, switch, main control box, bottom door, bearing housing lids, bearing housing, protect plate peg, blade, wing, frame, battery, battery lid, battery housing, housing unit, attachment member, mounting member, and support member.

### CROSS-REFERENCE TO RELATED APPLICATIONS

This application claims benefit of priority under 35 U.S.C. § 119(e) of U.S. Ser. No. 63/702,070, filed Oct. 1, 2024, the entire contents of which is incorporated herein by reference in its entirety.

### BACKGROUND

### Field

Disclosed herein are spinning wing decoys and methods for using them to attract animals to a location.

### Description of the Related Art

Outdoor enthusiasts, recreational hunters, and wildlife photographers have long recognized that live animals and game, particularly waterfowl, are attracted to areas that appear to be inhabited by similar animals. For this reason, people have used decoys to attract live game to a shooting distance of a hunter's gun or a prime viewing distance of a photographer's camera. However, decoys presently available on the market can have drawbacks. For example, stationary decoys can give the appearance of birds sitting on the water, but they are not particularly noticeable on their own from the perspective of a flying bird at a distance. Therefore, spinning wing decoys that have moving parts have been created to attract animals, such as those in U.S. Pat. Nos. 6,508,028 and 6,079,140. While these motion decoys have shown success in the past, they can also have drawbacks, such as an artificial appearance, which limits their success at attracting animals. For example, current motion decoys can have their moving components attached to the body of the decoy, which can produce unnatural vibrations and excessive noise, leading many animals to learn to become “decoy-wise” and avoid such decoys. Moreover, current motion decoys that have their moving components attached to the body of the decoy cannot be seen by waterfowl from far distances because the “wing” components are too small. To increase the wing size would require an impractically large increase in body size for the typical motion decoy to remain proportional.

Consequently, there is need for new spinning wing decoys that can give a realistic presentation without producing unnatural vibrations and noise, and that can easily be seen by waterfowl from a further distance than typical motion decoys.

### SUMMARY

Provided herein are spinning wing decoys and methods for using them to attract wildlife. In a specific embodiment, a spinning wing decoy includes: one or more axles, one or more axle hubs, one or more drive shafts, one or more motors, one or more motor housings, one or more motor doors, one or more main control boxes, one or more bottom doors, one or more retainer rings, one or more remote controllers, one or more receivers, one or more transmitters, one or more computers, one or more switches, one or more bearing housing lids, one or more bearing housings, one or more protect plates, one or more pegs, one or more blades, one or more wings, one or more frames, one or more batteries, one or more battery lids, one or more battery housings, one or more housing units, one or more attachment members, one or more mounting members, and one or more support members.

In another specific embodiment, a method of using a spinning wing decoy includes: placing a spinning wing decoy in nature, where the spinning wing decoy comprises: one or more axles, one or more axle hubs, one or more drive shafts, one or more motors, one or more motor housings, one or more motor doors, one or more retainer rings, one or more remote controllers, one or more receivers, one or more transmitters, one or more computers, one or more switches, one or more main control boxes, one or more bottom doors, one or more bearing housing lids, one or more bearing housings, one or more protect plates, one or more pegs, one or more blades, one or more wings, one or more frames, one or more batteries, one or more battery lids, one or more battery housings, one or more housing units, one or more attachment members, one or more mounting members, and one or more support members; and activating the electric motor to engage the at least one wing.

The disclosed invention attracts game fowl that typical spinning wing decoys existing in the prior art do not, as the disclosed invention can be seen by game fowl from much farther away. To that end, the disclosed invention gives a much different appearance than previous spinning wing decoys, which is critical to the spinning wing concept as many game fowl have become “decoy wise” from repeated exposure to the prior art spinning wing decoys. The disclosed invention is much smoother and quieter than any spinning wing decoys existing in the prior art, further improving the efficacy of the disclosed invention in attracting game fowl and preventing said game fowl from becoming “decoy wise” or otherwise learning to detect the presence of a decoy by excessive sound and/or mechanical noise.

### BRIEF DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 shows an embodiment of the spinning wing decoy.

FIG. 2 shows an axle for an embodiment of the spinning wing decoy.

FIG. 3 shows a motor door for an embodiment of the spinning wing decoy.

FIG. 4 shows a main control box for an embodiment of the spinning wing decoy.

FIG. 5 shows a bottom door for an embodiment of the spinning wing decoy.

FIG. 6 shows a bearing housing lid for an embodiment of the spinning wing decoy.

FIG. 7 shows a bearing housing for an embodiment of the spinning wing decoy.

FIG. 8 shows a protect plate for an embodiment of the spinning wing decoy.

FIG. 9 shows an axel hub for an embodiment of the spinning wing decoy.

FIG. 10 shows a blade for an embodiment of the spinning wing decoy.

FIG. 11 shows a frame for an embodiment of the spinning wing decoy.

FIG. 12 shows a battery lid for an embodiment of the spinning wing decoy.

FIG. 13 shows a battery housing for an embodiment of the spinning wing decoy.

FIG. 14 shows a bearing housing and bearing housing lid in the open position with a bearing inside.

### DETAILED DESCRIPTION

In one or more embodiments, the spinning wing decoy can include, but are not limited to: one or more axels, one or more axel hubs, one or more drive shafts, one or more motors, one or more motor housings, one or more motor doors, one or more retainer rings, one or more remote controllers, one or more receivers, one or more transmitters, one or more switches, one or more main control boxes, one or more bottom doors, one or more bearing housing lids, one or more bearing housings, one or more protect plates, one or more pegs, one or more blades, one or more wings, one or more frames, one or more batteries, one or more battery lids, one or more battery housings, one or more housing units, one or more attachment members, one or more mounting members, one or more support members, and combinations thereof.

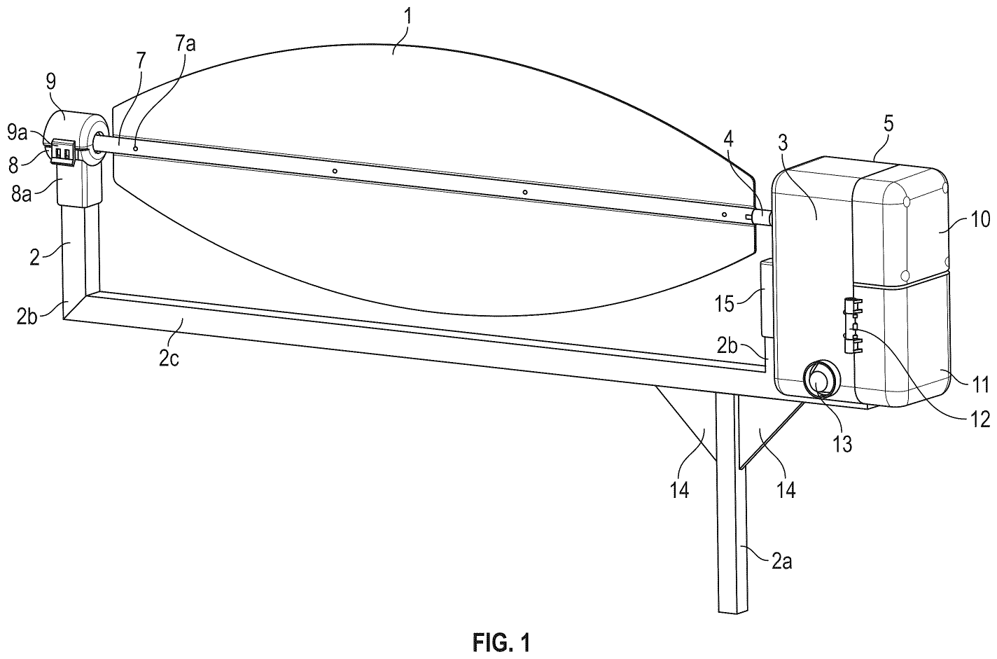

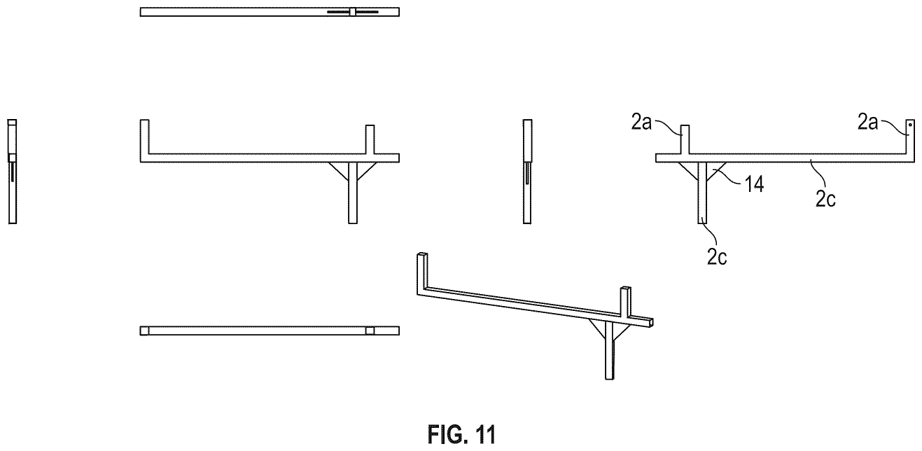

Each of the listed components of the spinning wing decoy can include, but are not limited to: plastic, elastomer, metal, alloy, ceramic, glass, wood, rubber, fiber, and combinations thereof. The listed components of the spinning wing decoy can be made by blow molding plastic, such as extrusion blow molding, injection blow molding, and injection stretch blow molding. Further, each of the listed components of the spinning wing decoy can be attached to or integrally formed with any of the other listed components. In one or more embodiments, any of the listed components of the spinning wing decoy can be absent. FIGS. 1-14 show embodiments of a spinning wing decoy and embodiments of components of a spinning wing decoy.

The spinning wing decoy can include a length, height, width, thickness, radius, first end, front side, second end, back side, right side, left side, top side, bottom side, outer surface, inner surface, and interior space. The spinning wing decoy can include, but are not limited to: avian decoys, waterfowl decoys, duck decoys, mallard decoys, quail decoys, dove decoys, pigeon decoys, hawk decoys, goose decoys, and other spinning wing decoys.

Turning to FIG. 1, the figure shows an embodiment of a spinning wing decoy. In such embodiment, a wing member 1 is removably attached to an axel 7, which axel may further comprise recesses 7a to facilitate attachment of the wing 1 via pins, screws, or other attachment means. Said axel 7 is operatively coupled at one end to a member, which member may be an axel hub 4, projecting into the main control box 3 of a motor housing 5 and which member may be operatively coupled to a motor inside the main control box 3 of the motor housing 5 to allow the motor to rotate the axel 7 and wing member 1. The motor housing 5 may comprise a main control box 3, a motor door 10, and a bottom door 11, wherein the motor door may allow access to a motor that may be housed inside the motor compartment of the main control box 3 and the bottom door may allow access to a battery that may be housed inside the battery compartment of the main control box 3. Said bottom door may be attached to the main control box 3 by one or more hinges 12. The main control box may further comprise a button 13 which is operatively connected to the battery and motor such that pressing the button 13 allows a user to turn the motor on or off. The main control box may further comprise a sleeve 15 to allow easy attachment to one of the vertical members 2b of the frame 2.

Axel 7 rests in a bearing housing 8 which may contain a bearing into which the axel 7 is situated so that it can freely rotate upon being turned by the motor. The bearing housing 8 further comprises a shaft 8a which can attach to the frame, and a bearing housing lid 9 which may be secured to the bearing housing 8 by a bearing housing lid catch 9a. Said bearing may be made of a material such as a polymer, a ceramic, a metal, a natural material, or a composite. In some embodiments, said bearing material may be chosen in order to reduce sound and/or mechanical noise caused by the turning of the axel.

The bearing housing 8 and the main control box 3 may be situated on a frame 2 which may be u-shaped and may further comprise two vertical members 2b, a horizontal member 2c, and a support member 2a. The u-shaped frame may further comprise supports at the perpendicular joinder of the support member 2a and the horizontal member 2c. This configuration allows the bearing housing 8 and motor housing 5 to each be situated on one of the vertical members 2b such that the axel is parallel to the horizontal member 2c of the u-frame 2. Further, the support member 2a may allow the decoy to be installed in the ground by inserting the grounding member 2a of the u-shaped frame into the ground or otherwise attaching the decoy to an object. The frame 2 may further comprise one or more supports 14 which strengthen the attachment between the support member 2a to the frame 2. Said u-shaped frame may be made of square metal tubing, rectangular metal tubing, cylindrical tubing, or other shapes and materials of tubing.

In some embodiments, including but not limited to the embodiment of FIG. 1, the spinning wing decoy can include a single large blade or wing member 1 attached to a U-frame of square tubing 2. The terms blade, wing, and wing member are used interchangeably herein to signify a structure that is to be manipulated by the motor in order to cause a visual effect that attracts animals, specifically avian animals. In some embodiments, the blade 1 can have diverging colors on each side or on portions of at least one side. For example, the blade can include a black or dark color on one side and a white or light color on the other side to provide a contrast. In some embodiments, the blade 1 when at or above a certain speed, can produced a flash or strobe-like optical that can be highly attractive to certain game birds, as it simulated the optical given off by actual birds. The spinning wing decoy can be effective at attracting certain types of game birds, and thereby became very popular with hunters.

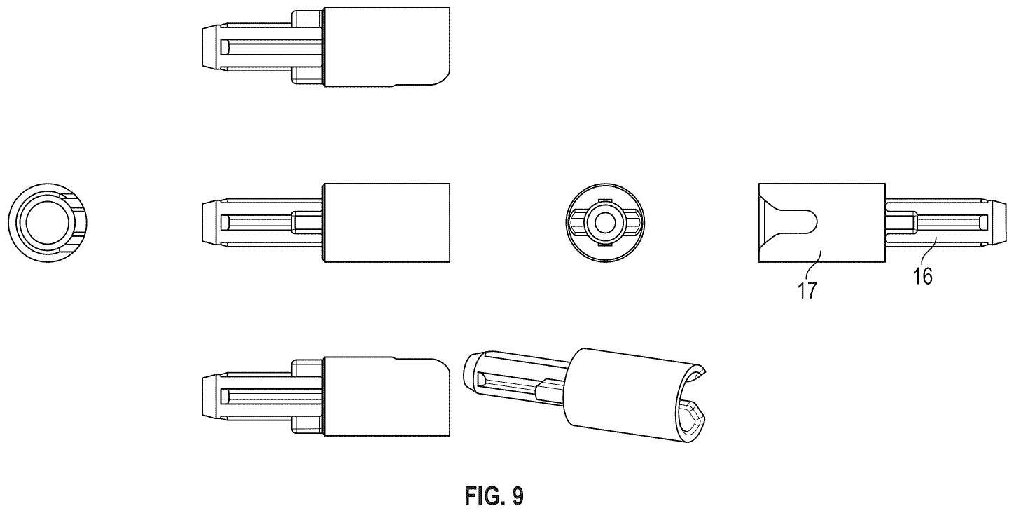

The one or more blade 1 can include, but are not limited to: a flat shape, wing shape, contoured shape, bowed shape, paddle shape, and semi-helical shape. Likewise, wings may be any combination of the foregoing; for example, it may be substantially flat with a curvature on only one end, or on both ends. The blade 1 can include a length, height, width, thickness, radius, first end, front side, second end, back side, right side, left side, top side, bottom side, outer surface, inner surface, and interior space. The wing can include a substantially flat shape having a terminating, distal end. In an embodiment, the wings can be positioned external to the motor housing 5 with a member 4 projecting into the motor housing 5 which member is operatively coupled to the motor such as through a drive shaft of the electric motor to allow the motor to rotate the one or more wings 1. Said member may be an axel hub 4 as shown in FIG. 9. Said axel hub 4 may further comprise an axel attachment side 16 and a drive shaft attachment side 17.

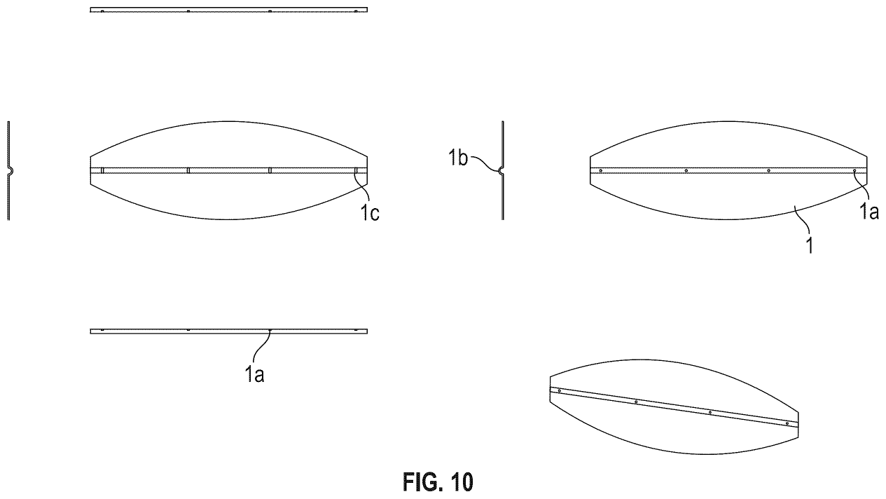

Turning to FIG. 10, in the shown embodiment, the frame may comprise a support member, a horizontal member, two vertical members, and two supports to reinforce the connection of the support member to the horizontal member.

In another embodiment, the housing unit can have two wings or blades, one on each opposing side of the motor housing 5, that each project into the motor housing, where each wing is operatively coupled to the one or more electric motors such that said electric motors can rotate the wings 1 either independently or concurrently. In another embodiment, the spinning wing decoy can include a first wing on one side of the body and a second wing on the other side of said body, where the wings extend laterally out and away from the motor housing unit, each terminating in a respective distal end and devoid of any supporting restraint at the distal end, each of the wing being directly attached to a separate wing attachment member laterally disposed with respect to the motor housing unit 5 and extending along a longitudinal axis.

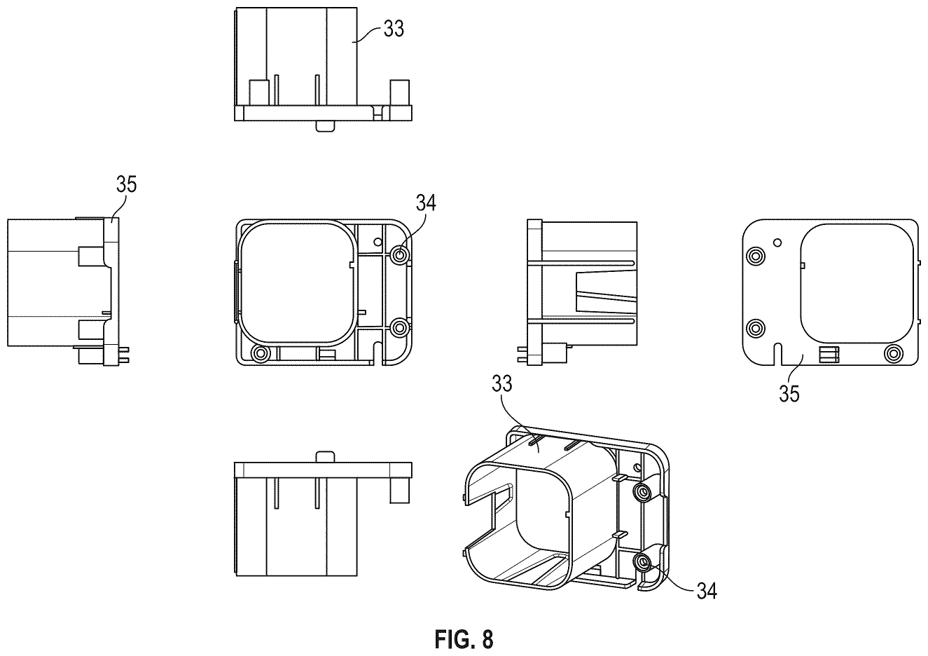

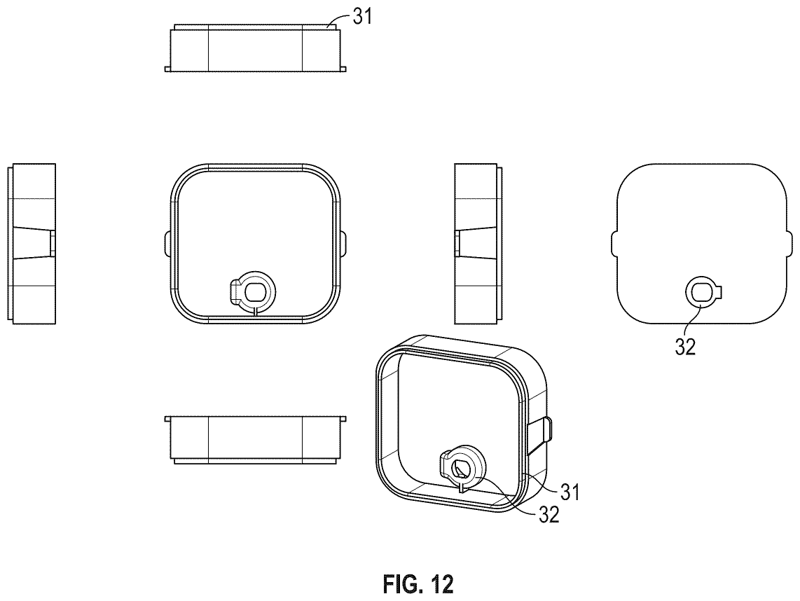

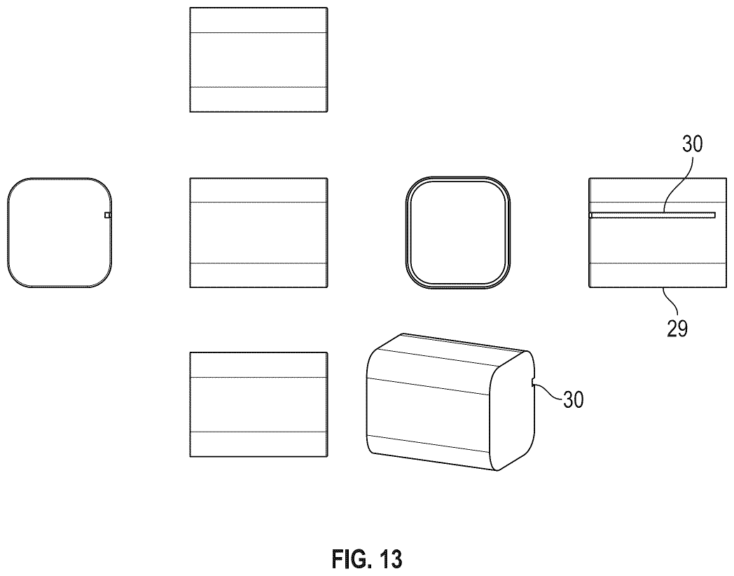

In some embodiments, the motor housing may further comprise a battery housing, such as in FIG. 13, which battery housing may further comprise a casing 29 and a channel 30 to protect the battery from moisture and to minimize vibrations that could be caused by the operation of the motor and further contribute to the quiet operation of the decoy. In some embodiments, the motor housing may further comprise a battery lid, such as in FIG. 12, which battery lid further comprises a lip 31 allowing the snug fit of the lid into the battery housing and an access plug 32 allowing access to the battery in the housing for wiring to the motor. In yet another embodiment, the motor housing may further comprise a protect plate, as in FIG. 8, into which a battery housing and/or battery lid may fit. The protect plate may further comprise a battery housing sleeve 33, pegs 34, and a faceplate 35. Said battery housing sleeve 33 may prevent excessive vibrations of the battery and contribute to the sound dampening effect of the motor housing. Said pegs 34 provide further means of securing the battery housing to reduce any excess vibration due to the operation of the motor and to contribute to the sound dampening qualities of the decoy in operation. The faceplate 35 is designed to fit snugly in the motor housing and reduce movement of the battery housing in the motor housing, contributing to the sound dampening effect of the motor housing.

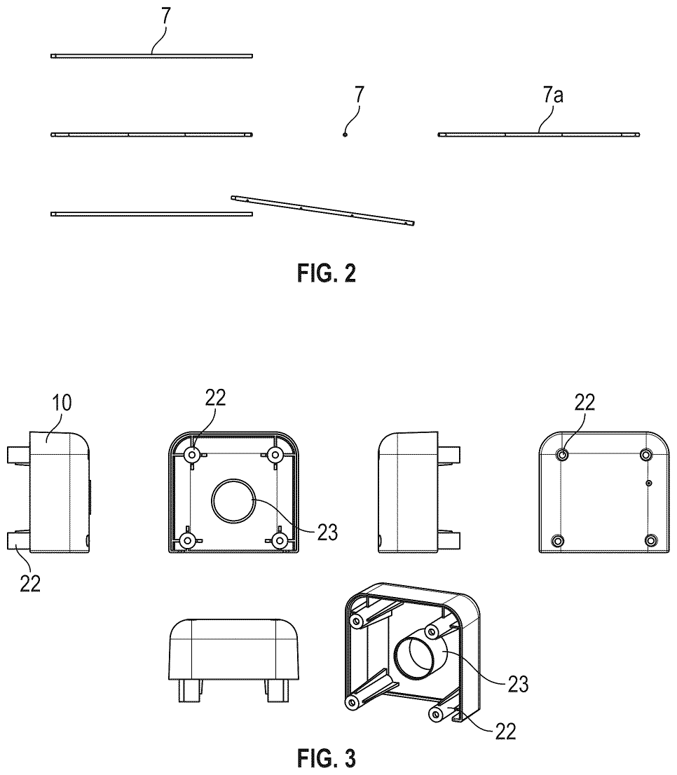

FIG. 2 depicts several views of an embodiment of an axel. Said axel 7 may extend along a longitudinal axis and may further comprise pinholes 7a to allow rigid attachment of the axel to the one or more wings. In addition to or in lieu of pinholes, recesses and slits may also be used to attach the axel to the one or more wings. FIG. 10 depicts several views of an embodiment of such a wing 1 which further may comprise pinholes 1a and a recessed channel 1b which may accommodate an axel and allow the rigid attachment of said axel and said wing using any appropriate fastening means including but not limited to screws or pins. FIG. 10 also shows an embodiment of a wing member with slits 1c in lieu of pinholes.

The wing 1 is operatively connected to the motor to allow the motor to manipulate the wing. In a preferred embodiment, the motor acts upon the wing to cause it to rotate about an axis. In one embodiment, the wing can be operatively connected to the electric motor with the one or more drive shaft adaptors and/or wing attachment member. FIG. 9 depicts an embodiment of an axel hub, which is an example of a type of drive shaft adaptor which allows the operational connection of the axel at the axel end of the adaptor with the drive shaft of an electric motor at the motor end of the adaptor. In another embodiment, the spinning wing decoy can include one or more wings residing external to the motor housing unit with a member projecting into the housing that is operatively coupled to the motor such as through a drive shaft of the electric motor to allow the electric motor to rotate the one or more wings. In another embodiment, the electric motor can be operatively connected to the one or more wings. In another embodiment, the wings can be positioned on a left side and a right side of the spinning wing decoy. In another embodiment, the electric motor can be configured to rotate the wings in the same direction or different directions. In another embodiment, the electric motor can cause the one or more wings to produce flapping maneuvers. In yet another embodiment, the one or more wings can be positioned at the sides of the head section and/or tail section of the spinning wing decoy.

The wing can include a length that varies widely. For example, the wing can include a length from a short of about 0.1 cm, about 1.0 cm, or 2.0 cm, to a long of about 8.0 cm, about 10.0 cm, or about 20.0 cm. In another example, the wing can include a length from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm. In another example, the spinning wing decoy can include a blade of about 22 inches long with partial circular edges with a maximum height of 8 inches.

The wing can include a width that varies widely. For example, the wing can include a width from a short of about 0.1 cm, about 1.0 cm, or 2.0 cm, to a long of about 8.0 cm, about 10.0 cm, or about 20.0 cm. In another example, the wings can include a width from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The wing can include a height that varies widely. For example, the wings can include a height from a short of about 0.1 cm, about 1.0 cm, or 2.0 cm, to a long of about 8.0 cm, about 10.0 cm, or about 20.0 cm. In another example, the wings can include a height from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

In some embodiments, the wing and/or blade can be supported by a cylindrical axle to add rigidity to the blade and allow attachment to the frame on both ends. A short vertical piece was attached to the bottom or horizontal member supporting the verticals at each end, for the purpose of mounting the device to a support pole or stake. In some embodiments, a DC motor can be mounted to one of the vertical risers with the single motor shaft protruding through the riser and the axle of the blade was connected to the motor shaft such that the blade was turned at the same speed as the motor. In some embodiments, the terminal end of the axle rested in an opening (hole) or sleeve in the opposite vertical, thereby holding the axle of the blade in line with the motor shaft.

The use of a larger blades and/or wings can produce a larger strobe or flash that can be seen from a much farther distance than a pair of smaller blades, allowing for long-range attraction of game birds. Also, the larger blade can give a different look then when a pair of blades in use. For example, the game birds for which the spinning wing decoys is used to attract will become accustomed to man-made devices and learn to identify them and dangerous to the birds and thus a new or different look is often required to facilitate success.

The spinning wing decoy is visible from a long-range distance by game birds. Assuming relatively clear visibility conditions, the spinning wing decoy is visible from a distance of a short of about 0 yards, 10 yards, 20 yards, or 30 yards to a long of about 50 yards, 100 yards, 500 yards, 2000 yards or 5000 yards. In a preferred embodiment, the spinning wing decoy is visible from a distance of about 20 yards to about 200 yards.

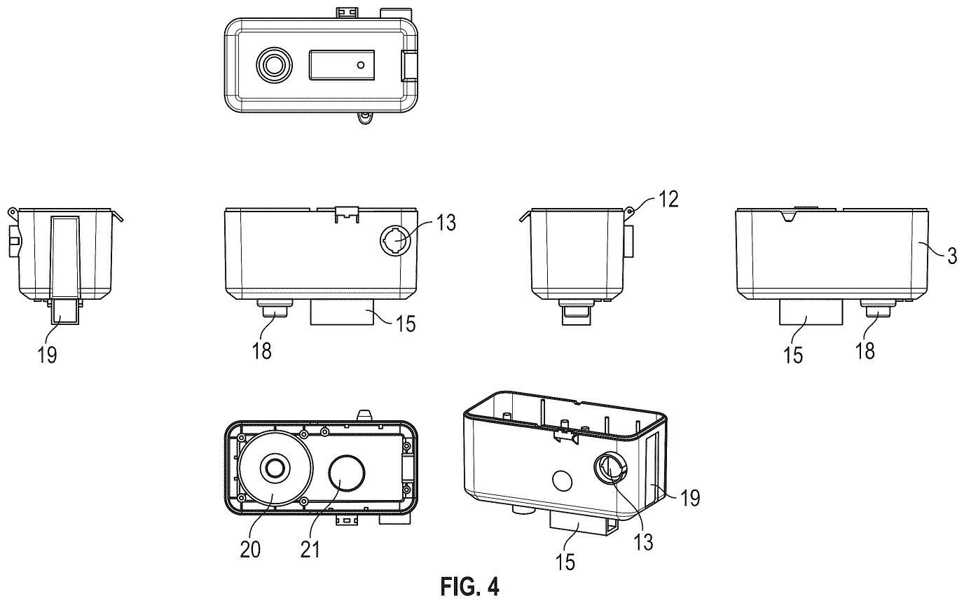

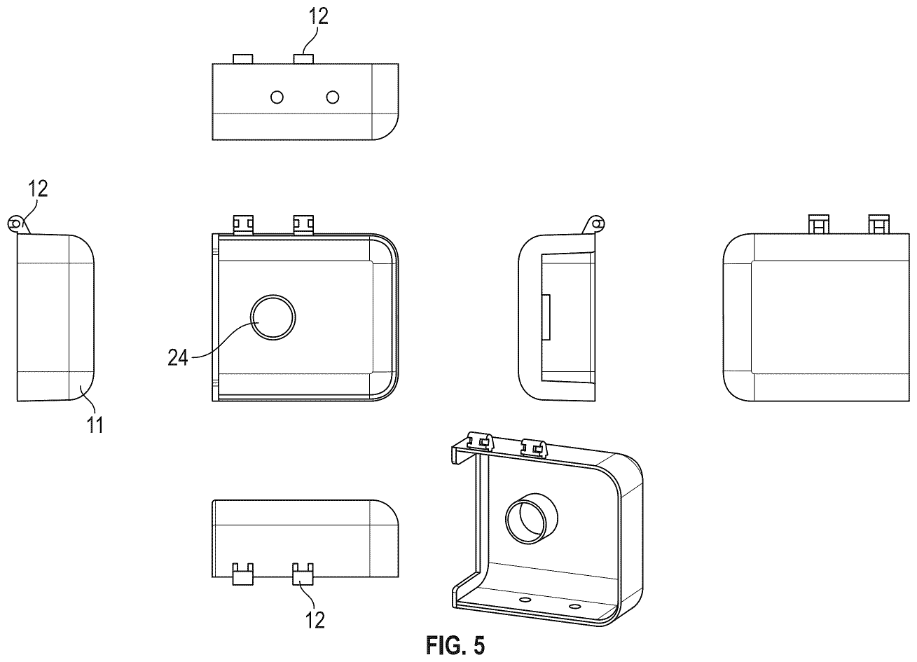

In some embodiments, spinning wing decoys can include a pair of removable housings, one attached to each of two vertical members of the U-frame. The first housing is the motor housing further comprising a main control box 3, a motor door, and a bottom door. The motor housing may contain all of the mechanical and electrical needed for the decoy to function as designed. A second removable housing, referred to as the bearing housing, is on the other or terminal end that houses a bearing to support the axle. Turning to FIG. 4, a main control box 3 is shown, wherein the main control box has a sleeve 15 for attaching to the vertical member of the frame, an orifice 18 allowing the axel hub to enter the motor portion of the housing, a button 13 allowing a user to turn the motor on or off, a horizontal member recess 19 to further stabilize the main control box 3 on the horizontal member of the frame to decrease vibrations, and one or more dampening means such as a motor recess 20 inside the main control box allowing the motor to be fixed inside the housing such that it does not unduly vibrate when in operation. Similarly, a battery recess 21 may be included to reduce rattling or vibrations. The main control box may further comprise a hinge 12 to allow the bottom door to be opened easily to change the battery. Such a main control box may further be coupled with a motor door as in FIG. 3 and a bottom door as in FIG. 5 to form the motor housing. Turning to FIG. 3, the motor door 10 may further comprise one or more pegs 22 allowing the motor door 10 to be securely fastened via screws or other means to the main control box such that there is minimal vibration when the motor is in operation. The motor door 10 may further comprise an axel hub stabilizing recess 23 to prevent vibrations during operation. Turning to FIG. 5, the bottom door 11 may further comprise one or more hinges 12 allowing ease of access to a battery compartment in the main control box 3. The bottom door 11 may further comprise a stabilizing recess 24 to prevent the battery from vibrating in the motor housing.

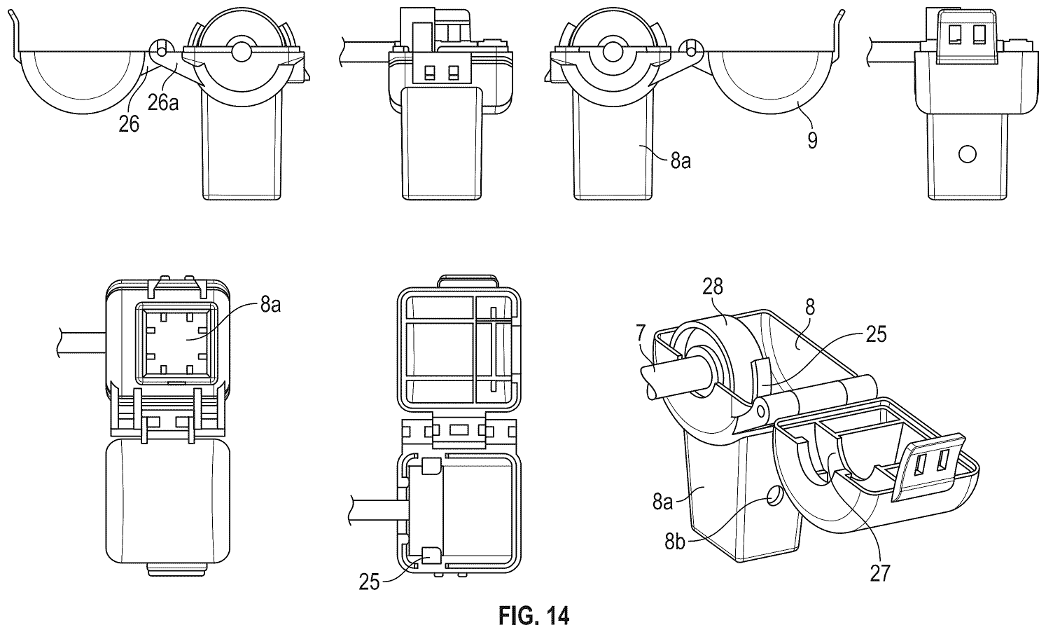

FIG. 14 depicts an embodiment of the bearing housing and bearing housing lid together with a bearing situated in the housing. The bearing housing may further comprise a hinge 26a to allow attachment to corresponding hinge 26 the bearing housing lid 9, a mounting tube 8a to allow snug installation of the bearing housing 8 on the u-frame vertical member, a hole 8b for securing the mounting tube to the u-frame vertical member, a bottom catch 9b to allow the snug closure of a bearing housing lid, and one or more dampening means, including but not limited to one or more vibration reducing bumpers 25 and one or more stabilizing recesses 27 such that the bearing may rotate noiselessly in the bearing housing when the bearing housing lid is closed. The bearing housing lid may further comprise a hinge to allow pivotable attachment to the bearing housing, one or more internal recesses to prevent transverse movement of the bearing during rotation, resulting in reduced noise during operation, and a top catch to fit snugly with the bottom catch of the bearing housing such that the bearing housing and bearing housing lid may close during operation. The hinge and catch system further allows the easy insertion and removal of the blade for replacement or repositioning of the decoy by simply opening the bearing housing by decoupling the top and bottom catches, and sliding the wing and axel horizontally towards the bearing housing side of the u-frame to avoid the bearing guides and allow removal of the wing and axel.

In some embodiments, spinning wing decoys can include a battery powered DC motor and other electrical is mounted inside and attached to first housing which provides a sleeve to mount over the vertical riser. The vertical riser terminates below the motor shaft to allow attachment of the blade coupling. Beneath the motor in a separate compartment is a battery holder to accommodate a specially designed battery designed to allow easy insertion and removal. The battery holder housing is designed to receive a plug-in remote-control receiver and printed circuit board to control the functions of the decoy. A special wiring harness using a single male plug-in connects the battery to the electrical components including the circuit board to allow the motor to drive the blade. In some embodiments, spinning wing decoys can include a three-button remote control is provided that allows for the functions of off—on—intermittent operation. In some embodiments, spinning wing decoys can include a separate power chord is provided which connects the motor directly to the battery for use as an emergency wire should the user experience any issues with the electrical components.

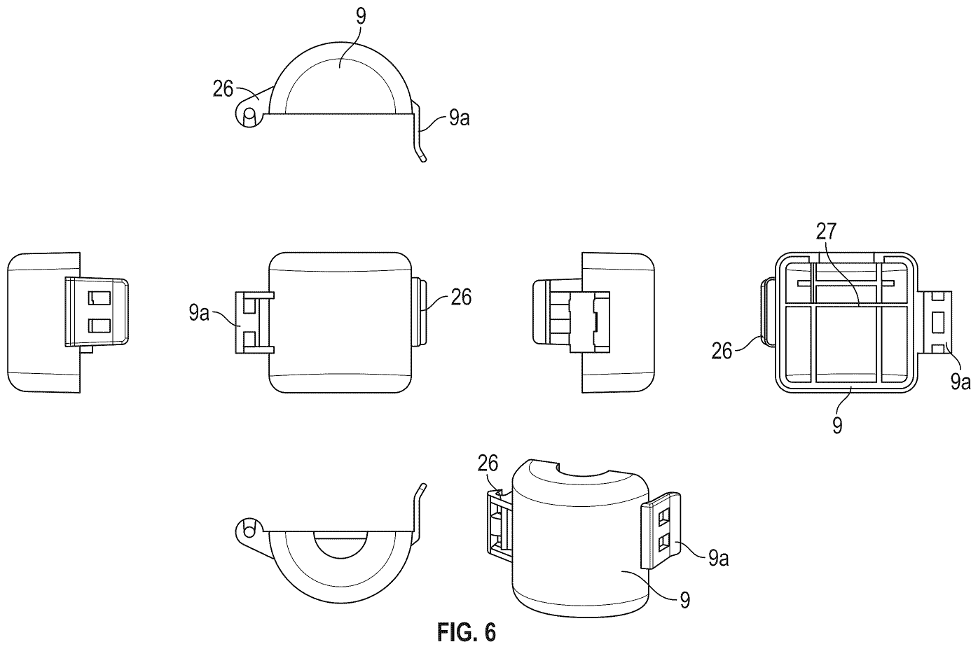

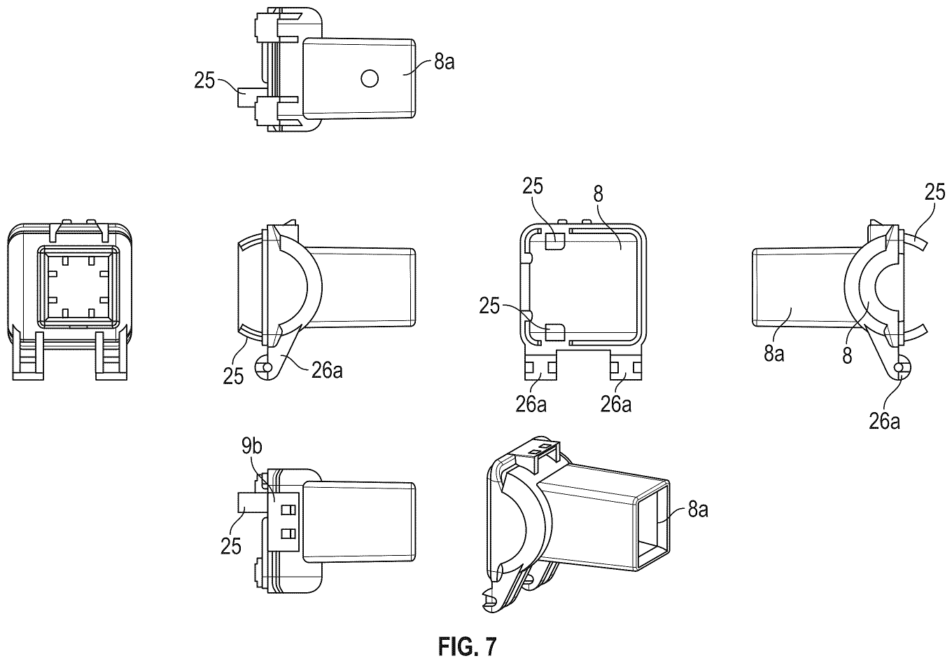

In some embodiments, spinning wing decoys can include a housing bearing supporting the terminal end of the blade axle to provide for smooth, quiet operation of the blade when turning. It is removably mounted to the vertical opposite the motor end. In some embodiments, the top half of the housing is hinged allowing the housing to be opened to remove the blade. Turning to FIG. 4, a control housing is shown, wherein the control housing has a sleeve for attaching to the frame, an orifice allowing the drive shaft to enter the motor portion of the housing, and a recess inside allowing the motor to be fixed inside the housing such that it does not unduly vibrate when in operation. Turning to FIGS. 6, 7, and 14, an embodiment of a bearing housing and bearing housing lid is depicted. FIG. 6 shows an embodiment of a bearing housing lid 9 further comprising a hinge 26 side and a latch 9a side, with further recesses 27 inside to guide the rotation of the bearing and omit undue vibrations or translational motion that would cause sound. The latch is sometimes also referred to herein as a catch or a top catch. FIG. 7 shows an embodiment of a bearing housing 8 further comprising a mounting tube 8a that may fit snugly over the vertical appendage of the u-frame, reducing vibrations during operation. The bearing housing further comprises one or more hinges 26a, a bottom catch 9b (also sometimes called the bottom latch) internal bearing guides 25 to reduce transverse motion of the bearing and reduce noise during the operation of the decoy. In a preferred embodiment, the bearing may be made of a rubber, rubber composite, or other material that reduces noise during operation, allowing the decoy to operate silently.

FIG. 14 depicts an embodiment of the bearing housing and bearing housing lid together with a bearing situated in the housing. The bearing housing may further comprise one or more vibration reducing bearing guides 25 such that the bearing may rotate noiselessly in the bearing housing when the bearing housing lid is closed.

In some embodiments, spinning wing decoys can include the axle of the blade attached to the motor shaft with a hub fitted with a cavity in the other end that slides over the motor shaft. A stud is mounted in the motor shaft that slides into a slot in the hub to cause the blade to rotate with the motor. A retainer ring can be located in second housing that provides as a seat for the axle bearing. The retainer ring also requires that the bearing/axle system be slid horizontally sufficient that the blade hub can be slid on or off of the motor shaft to prevent the axle from being rotated on the bearing end before the blade hub is detached from the motor shaft.

In some embodiments, spinning wing decoys can provide for easy removal and replacement of blade. In some embodiments, spinning wing decoys can include an axle with terminal end bearing.

Turning to FIG. 2, the one or more axles 7 can include a length, height, width, thickness, radius, first end, front side, second end, back side, right side, left side, top side, bottom side, outer surface, inner surface, and interior space. The axle can include one or more recesses 7a.

The axle can include a length that varies widely. For example, the axle can include a length from a short of about 1.0 cm, about 3.0 cm, or 5.0 cm, to a long of about 40.0 cm, about 50.0 cm, or about 60.0 cm. In another example, the axle can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle can include a width that varies widely. For example, the axle can include a width from a short of about 1.0 cm, about 3.0 cm, or 5.0 cm, to a long of about 40.0 cm, about 50.0 cm, or about 60.0 cm. In another example, the axle can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle can include a height that varies widely. For example, the axle can include a height from a short of about 1.0 cm, about 3.0 cm, or 5.0 cm, to a long of about 40.0 cm, about 50.0 cm, or about 60.0 cm. In another example, the axle can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle can include a radius that varies widely. For example, the axle can include a radius from a short of about 1.0 cm, about 3.0 cm, or 5.0 cm, to a long of about 40.0 cm, about 50.0 cm, or about 60.0 cm. In another example, the axle can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle can include a weight that varies widely. For example, the axle can include a weight from a low of about 0.1 kg, about 0.5 kg, or 1 kg, to a high of about 5.0 kg, about 10.0 kg, or about 20.0 kg. In another example, the axle can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more main control boxes can include a length, height, width, thickness, radius, first end, front side, second end, back side, right side, left side, top side, bottom side, outer surface, inner surface, and interior space. The main control box can include one or more recesses.

The main control box can include a length that varies widely. For example, the main control box can include a length from a short of about 1.0 cm, about 3.0 cm, or 5.0 cm, to a long of about 40.0 cm, about 50.0 cm, or about 60.0 cm. In another example, the main control box can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The main control box can include a width that varies widely. For example, the axle hub can include a width from a short of about 1.0 cm, about 3.0 cm, or 5.0 cm, to a long of about 40.0 cm, about 50.0 cm, or about 60.0 cm. In another example, the axle hub can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The main control box can include a height that varies widely. For example, the main control box can include a height from a short of about 1.0 cm, about 3.0 cm, or 5.0 cm, to a long of about 40.0 cm, about 50.0 cm, or about 60.0 cm. In another example, the main control box can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The main control box can include a radius that varies widely. For example, the main control box can include a radius from a short of about 1.0 cm, about 3.0 cm, or 5.0 cm, to a long of about 40.0 cm, about 50.0 cm, or about 60.0 cm. In another example, the hub can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The main control box can include a weight that varies widely. For example, the main control box can include a weight from a low of about 0.1 kg, about 0.5 kg, or 1 kg, to a high of about 5.0 kg, about 10.0 kg, or about 20.0 kg. In another example, the main control box can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

Turning to FIG. 3, the one or more axle hubs 10 can include a length, height, width, thickness, radius, first end, front side, second end, back side, right side, left side, top side, bottom side, outer surface, inner surface, and interior space. The axle hub can include one or more recesses.

The axle hub can include a length that varies widely. For example, the axle hub can include a length from a short of about 1.0 cm, about 3.0 cm, or 5.0 cm, to a long of about 40.0 cm, about 50.0 cm, or about 60.0 cm. In another example, the axle hub can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The one or more axle hub can include a width that varies widely. For example, the axle hub can include a width from a short of about 1.0 cm, about 3.0 cm, or 5.0 cm, to a long of about 40.0 cm, about 50.0 cm, or about 60.0 cm. In another example, the axle hub can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle hub can include a height that varies widely. For example, the axle hub can include a height from a short of about 1.0 cm, about 3.0 cm, or 5.0 cm, to a long of about 40.0 cm, about 50.0 cm, or about 60.0 cm. In another example, the axle hub can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle hub can include a radius that varies widely. For example, the axle can include a radius from a short of about 1.0 cm, about 3.0 cm, or 5.0 cm, to a long of about 40.0 cm, about 50.0 cm, or about 60.0 cm. In another example, the hub can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The axle hub can include a weight that varies widely. For example, the axle can include a weight from a low of about 0.1 kg, about 0.5 kg, or 1 kg, to a high of about 5.0 kg, about 10.0 kg, or about 20.0 kg. In another example, the axle can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more housing units can include, but are not limited to: the one or more head sections, the one or more body sections, and the one or more tail sections. The housing unit can include a length, height, width, thickness, radius, first end, front side, second end, back side, right side, left side, top side, bottom side, outer surface, inner surface, and interior space. The housing unit can include one or more recesses. The housing unit can include at least a portion of the outer surface shaped to resemble an avian animal. In some embodiments, the exterior surface can be painted to look like an avian animal.

The housing unit can include a length that varies widely. For example, the housing unit 3 can include a length from a short of about 1.0 cm, about 3.0 cm, or 5.0 cm, to a long of about 40.0 cm, about 50.0 cm, or about 60.0 cm. In another example, the housing unit can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The housing unit can include a width that varies widely. For example, the housing unit can include a width from a short of about 1.0 cm, about 3.0 cm, or 5.0 cm, to a long of about 40.0 cm, about 50.0 cm, or about 60.0 cm. In another example, the housing unit can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The housing unit can include a height that varies widely. For example, the housing unit can include a height from a short of about 1.0 cm, about 3.0 cm, or 5.0 cm, to a long of about 40.0 cm, about 50.0 cm, or about 60.0 cm. In another example, the housing unit can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The housing unit can include a radius that varies widely. For example, the housing unit can include a radius from a short of about 1.0 cm, about 3.0 cm, or 5.0 cm, to a long of about 40.0 cm, about 50.0 cm, or about 60.0 cm. In another example, the housing unit can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The housing unit can include a weight that varies widely. For example, the housing unit can include a weight from a low of about 0.1 kg, about 0.5 kg, or 1 kg, to a high of about 5.0 kg, about 10.0 kg, or about 20.0 kg. In another example, the housing unit can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more doors can include a length, height, width, thickness, radius, first end, front side, second end, back side, right side, left side, top side, bottom side, outer surface, inner surface, and interior space. The door can include one or more recesses.

The door can include a length that varies widely. For example, the door can include a length from a short of about 1.0 cm, about 3.0 cm, or 5.0 cm, to a long of about 40.0 cm, about 50.0 cm, or about 60.0 cm. In another example, the door can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The door can include a width that varies widely. For example, the door can include a width from a short of about 1.0 cm, about 3.0 cm, or 5.0 cm, to a long of about 40.0 cm, about 50.0 cm, or about 60.0 cm. In another example, the door can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The door can include a height that varies widely. For example, the door can include a height from a short of about 1.0 cm, about 3.0 cm, or 5.0 cm, to a long of about 40.0 cm, about 50.0 cm, or about 60.0 cm. In another example, the door can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The door can include a radius that varies widely. For example, the door can include a radius from a short of about 1.0 cm, about 3.0 cm, or 5.0 cm, to a long of about 40.0 cm, about 50.0 cm, or about 60.0 cm. In another example, the door can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The door can include a weight that varies widely. For example, the door can include a weight from a low of about 0.1 kg, about 0.5 kg, or 1 kg, to a high of about 5.0 kg, about 10.0 kg, or about 20.0 kg. In another example, the door can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more bearing housings can include a length, height, width, thickness, radius, first end, front side, second end, back side, right side, left side, top side, bottom side, outer surface, inner surface, and interior space. The bearing housing can include one or more recesses.

The bearing housing can include a length that varies widely. For example, the bearing housing can include a length from a short of about 1.0 cm, about 3.0 cm, or 5.0 cm, to a long of about 40.0 cm, about 50.0 cm, or about 60.0 cm. In another example, the bearing housing can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing can include a width that varies widely. For example, the bearing housing can include a width from a short of about 1.0 cm, about 3.0 cm, or 5.0 cm, to a long of about 40.0 cm, about 50.0 cm, or about 60.0 cm. In another example, the bearing housing can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing can include a height that varies widely. For example, the bearing housing can include a height from a short of about 1.0 cm, about 3.0 cm, or 5.0 cm, to a long of about 40.0 cm, about 50.0 cm, or about 60.0 cm. In another example, the bearing housing can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing can include a radius that varies widely. For example, the bearing housing can include a radius from a short of about 1.0 cm, about 3.0 cm, or 5.0 cm, to a long of about 40.0 cm, about 50.0 cm, or about 60.0 cm. In another example, the bearing housing can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing can include a weight that varies widely. For example, the bearing housing can include a weight from a low of about 0.1 kg, about 0.5 kg, or 1 kg, to a high of about 5.0 kg, about 10.0 kg, or about 20.0 kg. In another example, the bearing housing can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more bearing housing lids can include a length, height, width, thickness, radius, first end, front side, second end, back side, right side, left side, top side, bottom side, outer surface, inner surface, and interior space. The bearing housing lid can include one or more recesses.

The bearing housing lid can include a length that varies widely. For example, the bearing housing can include a length from a short of about 1.0 cm, about 3.0 cm, or 5.0 cm, to a long of about 40.0 cm, about 50.0 cm, or about 60.0 cm. In another example, the bearing housing can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing lid can include a width that varies widely. For example, the bearing housing lid can include a width from a short of about 1.0 cm, about 3.0 cm, or 5.0 cm, to a long of about 40.0 cm, about 50.0 cm, or about 60.0 cm. In another example, the bearing housing lid can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing lid can include a height that varies widely. For example, the bearing housing lid can include a height from a short of about 1.0 cm, about 3.0 cm, or 5.0 cm, to a long of about 40.0 cm, about 50.0 cm, or about 60.0 cm. In another example, the bearing housing lid can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing lid can include a radius that varies widely. For example, the bearing housing lid can include a radius from a short of about 1.0 cm, about 3.0 cm, or 5.0 cm, to a long of about 40.0 cm, about 50.0 cm, or about 60.0 cm. In another example, the bearing housing lid can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The bearing housing lid can include a weight that varies widely. For example, the bearing housing lid can include a weight from a low of about 0.1 kg, about 0.5 kg, or 1 kg, to a high of about 5.0 kg, about 10.0 kg, or about 20.0 kg. In another example, the bearing housing lid can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more protect plates can include a length, height, width, thickness, radius, first end, front side, second end, back side, right side, left side, top side, bottom side, outer surface, inner surface, and interior space. The protect plate can include one or more recesses.

The protect plate can include a length that varies widely. For example, the protect plate can include a length from a short of about 1.0 cm, about 3.0 cm, or 5.0 cm, to a long of about 40.0 cm, about 50.0 cm, or about 60.0 cm. In another example, the protect plate can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The protect plate can include a width that varies widely. For example, the protect plate can include a width from a short of about 1.0 cm, about 3.0 cm, or 5.0 cm, to a long of about 40.0 cm, about 50.0 cm, or about 60.0 cm. In another example, the protect plate can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The protect plate can include a height that varies widely. For example, the protect plate can include a height from a short of about 1.0 cm, about 3.0 cm, or 5.0 cm, to a long of about 40.0 cm, about 50.0 cm, or about 60.0 cm. In another example, the protect plate can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The protect plate can include a radius that varies widely. For example, the protect plate can include a radius from a short of about 1.0 cm, about 3.0 cm, or 5.0 cm, to a long of about 40.0 cm, about 50.0 cm, or about 60.0 cm. In another example, the protect plate can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The protect plate can include a weight that varies widely. For example, the protect plate can include a weight from a low of about 0.1 kg, about 0.5 kg, or 1 kg, to a high of about 5.0 kg, about 10.0 kg, or about 20.0 kg. In another example, the protect plate can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more frames can include a length, height, width, thickness, radius, first end, front side, second end, back side, right side, left side, top side, bottom side, outer surface, inner surface, and interior space. The frame can include one or more recesses.

The frame can include a length that varies widely. For example, the frame can include a length from a short of about 1.0 cm, about 3.0 cm, or 5.0 cm, to a long of about 40.0 cm, about 50.0 cm, or about 60.0 cm. In another example, the frame can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The frame can include a width that varies widely. For example, the frame can include a width from a short of about 1.0 cm, about 3.0 cm, or 5.0 cm, to a long of about 40.0 cm, about 50.0 cm, or about 60.0 cm. In another example, the frame can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The frame can include a height that varies widely. For example, the frame can include a height from a short of about 1.0 cm, about 3.0 cm, or 5.0 cm, to a long of about 40.0 cm, about 50.0 cm, or about 60.0 cm. In another example, the frame can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The frame can include a radius that varies widely. For example, the frame can include a radius from a short of about 1.0 cm, about 3.0 cm, or 5.0 cm, to a long of about 40.0 cm, about 50.0 cm, or about 60.0 cm. In another example, the frame can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The frame can include a weight that varies widely. For example, the frame can include a weight from a low of about 0.1 kg, about 0.5 kg, or 1 kg, to a high of about 5.0 kg, about 10.0 kg, or about 20.0 kg. In another example, the frame can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more battery housings can include a length, height, width, thickness, radius, first end, front side, second end, back side, right side, left side, top side, bottom side, outer surface, inner surface, and interior space. The battery housing can include one or more recesses.

The battery housing can include a length that varies widely. For example, the battery housing can include a length from a short of about 1.0 cm, about 3.0 cm, or 5.0 cm, to a long of about 40.0 cm, about 50.0 cm, or about 60.0 cm. In another example, the battery housing can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The battery housing can include a width that varies widely. For example, the battery housing can include a width from a short of about 1.0 cm, about 3.0 cm, or 5.0 cm, to a long of about 40.0 cm, about 50.0 cm, or about 60.0 cm. In another example, the battery housing can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The battery housing can include a height that varies widely. For example, the battery housing can include a height from a short of about 1.0 cm, about 3.0 cm, or 5.0 cm, to a long of about 40.0 cm, about 50.0 cm, or about 60.0 cm. In another example, the battery housing can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The battery housing can include a radius that varies widely. For example, the battery housing can include a radius from a short of about 1.0 cm, about 3.0 cm, or 5.0 cm, to a long of about 40.0 cm, about 50.0 cm, or about 60.0 cm. In another example, the battery housing can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The battery housing can include a weight that varies widely. For example, the battery housing can include a weight from a low of about 0.1 kg, about 0.5 kg, or 1 kg, to a high of about 5.0 kg, about 10.0 kg, or about 20.0 kg. In another example, the battery housing can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more attachment members can include a length, height, width, thickness, radius, first end, front side, second end, back side, right side, left side, top side, bottom side, outer surface, inner surface, and interior space. The attachment member can include one or more recesses.

The attachment member can include a length that varies widely. For example, the attachment member can include a length from a short of about 1.0 cm, about 3.0 cm, or 5.0 cm, to a long of about 40.0 cm, about 50.0 cm, or about 60.0 cm. In another example, the attachment member can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The attachment member can include a width that varies widely. For example, the attachment member can include a width from a short of about 1.0 cm, about 3.0 cm, or 5.0 cm, to a long of about 40.0 cm, about 50.0 cm, or about 60.0 cm. In another example, the attachment member can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The attachment member can include a height that varies widely. For example, the attachment member can include a height from a short of about 1.0 cm, about 3.0 cm, or 5.0 cm, to a long of about 40.0 cm, about 50.0 cm, or about 60.0 cm. In another example, the attachment member can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The attachment member can include a radius that varies widely. For example, the attachment member can include a radius from a short of about 1.0 cm, about 3.0 cm, or 5.0 cm, to a long of about 40.0 cm, about 50.0 cm, or about 60.0 cm. In another example, the attachment member can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The attachment member can include a weight that varies widely. For example, the attachment member can include a weight from a low of about 0.1 kg, about 0.5 kg, or 1 kg, to a high of about 5.0 kg, about 10.0 kg, or about 20.0 kg. In another example, the attachment member can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more mounting members can include a length, height, width, thickness, radius, first end, front side, second end, back side, right side, left side, top side, bottom side, outer surface, inner surface, and interior space. The mounting member can include one or more recesses.

The mounting member can include a length that varies widely. For example, the mounting member can include a length from a short of about 1.0 cm, about 3.0 cm, or 5.0 cm, to a long of about 40.0 cm, about 50.0 cm, or about 60.0 cm. In another example, the mounting member can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The mounting member can include a width that varies widely. For example, the mounting member can include a width from a short of about 1.0 cm, about 3.0 cm, or 5.0 cm, to a long of about 40.0 cm, about 50.0 cm, or about 60.0 cm. In another example, the mounting member can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The mounting member can include a height that varies widely. For example, the mounting member can include a height from a short of about 1.0 cm, about 3.0 cm, or 5.0 cm, to a long of about 40.0 cm, about 50.0 cm, or about 60.0 cm. In another example, the mounting member can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The mounting member can include a radius that varies widely. For example, the mounting member can include a radius from a short of about 1.0 cm, about 3.0 cm, or 5.0 cm, to a long of about 40.0 cm, about 50.0 cm, or about 60.0 cm. In another example, the mounting member can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The mounting member can include a weight that varies widely. For example, the mounting member can include a weight from a low of about 0.1 kg, about 0.5 kg, or 1 kg, to a high of about 5.0 kg, about 10.0 kg, or about 20.0 kg. In another example, the mounting member can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more support members can include a length, height, width, thickness, radius, first end, front side, second end, back side, right side, left side, top side, bottom side, outer surface, inner surface, and interior space. The support member can include one or more recesses.

The support member can include a length that varies widely. For example, the support member can include a length from a short of about 1.0 cm, about 3.0 cm, or 5.0 cm, to a long of about 40.0 cm, about 50.0 cm, or about 60.0 cm. In another example, the support member can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The support member can include a width that varies widely. For example, the support member can include a width from a short of about 1.0 cm, about 3.0 cm, or 5.0 cm, to a long of about 40.0 cm, about 50.0 cm, or about 60.0 cm. In another example, the support member can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The support member can include a height that varies widely. For example, the support member can include a height from a short of about 1.0 cm, about 3.0 cm, or 5.0 cm, to a long of about 40.0 cm, about 50.0 cm, or about 60.0 cm. In another example, the support member can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The support member can include a radius that varies widely. For example, the support member can include a radius from a short of about 1.0 cm, about 3.0 cm, or 5.0 cm, to a long of about 40.0 cm, about 50.0 cm, or about 60.0 cm. In another example, the support member can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The support member can include a weight that varies widely. For example, the mounting member can include a weight from a low of about 0.1 kg, about 0.5 kg, or 1 kg, to a high of about 5.0 kg, about 10.0 kg, or about 20.0 kg. In another example, the mounting member can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more pegs can include a length, height, width, thickness, radius, first end, front side, second end, back side, right side, left side, top side, bottom side, outer surface, inner surface, and interior space. The peg can include one or more recesses. In some embodiments, spinning wing decoys can include a peg that is attached to the bottom cross bar of the U-Frame serving to mount the U-frame on a support pole or stake.

The peg can include a length that varies widely. For example, the peg can include a length from a short of about 1.0 cm, about 3.0 cm, or 5.0 cm, to a long of about 40.0 cm, about 50.0 cm, or about 60.0 cm. In another example, the peg can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The peg can include a width that varies widely. For example, the peg can include a width from a short of about 1.0 cm, about 3.0 cm, or 5.0 cm, to a long of about 40.0 cm, about 50.0 cm, or about 60.0 cm. In another example, the peg can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The peg can include a height that varies widely. For example, the peg can include a height from a short of about 1.0 cm, about 3.0 cm, or 5.0 cm, to a long of about 40.0 cm, about 50.0 cm, or about 60.0 cm. In another example, the peg can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The peg can include a radius that varies widely. For example, the peg can include a radius from a short of about 1.0 cm, about 3.0 cm, or 5.0 cm, to a long of about 40.0 cm, about 50.0 cm, or about 60.0 cm. In another example, the peg can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The peg can include a weight that varies widely. For example, the peg can include a weight from a low of about 0.1 kg, about 0.5 kg, or 1 kg, to a high of about 5.0 kg, about 10.0 kg, or about 20.0 kg. In another example, the peg can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The one or more retainer rings can include a length, height, width, thickness, radius, first end, front side, second end, back side, right side, left side, top side, bottom side, outer surface, inner surface, and interior space. The retainer ring can include one or more recesses.

The retainer ring can include a length that varies widely. For example, the retainer ring can include a length from a short of about 1.0 cm, about 3.0 cm, or 5.0 cm, to a long of about 40.0 cm, about 50.0 cm, or about 60.0 cm. In another example, the retainer ring can include a length from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The retainer ring can include a width that varies widely. For example, the retainer ring can include a width from a short of about 1.0 cm, about 3.0 cm, or 5.0 cm, to a long of about 40.0 cm, about 50.0 cm, or about 60.0 cm. In another example, the retainer ring can include a width from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The retainer ring can include a height that varies widely. For example, the retainer ring can include a height from a short of about 1.0 cm, about 3.0 cm, or 5.0 cm, to a long of about 40.0 cm, about 50.0 cm, or about 60.0 cm. In another example, the retainer ring can include a height from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The retainer ring can include a radius that varies widely. For example, the retainer ring can include a radius from a short of about 1.0 cm, about 3.0 cm, or 5.0 cm, to a long of about 40.0 cm, about 50.0 cm, or about 60.0 cm. In another example, the retainer ring can include a radius from about 1.0 cm to about 60.0 cm, about 2.0 cm to about 12.0 cm, about 3.0 cm to about 20.0 cm, about 5.0 cm to about 32.0 cm, about 10.0 cm to about 27.0 cm, or about 16.5 cm to about 42.0 cm.

The retainer ring can include a weight that varies widely. For example, the retainer ring can include a weight from a low of about 0.1 kg, about 0.5 kg, or 1 kg, to a high of about 5.0 kg, about 10.0 kg, or about 20.0 kg. In another example, the retainer ring can include a weight from about 0.1 kg to about 0.5 kg, about 0.4 kg to about 2.0 kg, about 0.8 kg to about 4.0 kg, about 3.0 kg to about 12.0 kg, about 1.0 kg to about 7.0 kg, or about 6.8 kg to about 18.0 kg.

The mounting member can include a length, height, width, thickness, radius, first end, front side, second end, back side, right side, left side, top side, bottom side, outer surface, inner surface, and interior space. The mounting member can include, but is not limited to, a cube shape and rectangular cuboid shape. The mounting member can include an angled portion. In an embodiment, the mounting member can be attached to and/or integrally formed with the head section, body section, tail section, housing unit, support member, electric motor housing, coupling member, battery housing, and/or electric motor. In another embodiment, the mounting member can be attached to the head section at a recess at a first end and a support member at the angled portion. In another embodiment, the mounting member can be attached to the head section at a recess using screws that further secure the electric motor housing, coupling member, battery housing, and/or electric motor into the interior space of the housing unit. By connecting to the mounting member, the vibrational force is transferred to the mounting member and thus to the support structure or member.

The spinning wing decoy can include an animation or movement to provide a display that can attract animal to the location of the spinning wing decoy. The one or more electric motors can be operatively attached to the axle, drive shaft, wing, and/or wing attachment member. In an embodiment, the animation or movement can include rotating and/or up and down flapping of the wings. In another embodiment, the spinning wing decoys can include the electric motor and a pair of wings that are operatively attached to the opposing sides of the axle and/or the drive shaft using a wing support member so that the electric motor can operate the wings, which can be positioned on the right side and left side of the decoy body and exterior housing unit. In some embodiments, spinning wing decoys can include an emergency wire bypass. In some embodiments, a frame and/or box can be welded to the support pole to hold the battery, or a stand-alone battery was placed on the ground beside the pole. In some embodiments, the spinning wing decoy can include a remote-control receiver that can be wired into the power cord between the battery and the motor. In some embodiments, spinning wing decoys can have all electrical components contained in removable housing. In some embodiments, spinning wing decoys can include a motor mounted to the housing and/or the frame. In some embodiments, spinning wing decoys can include rechargeable battery.

A key aspect of at least one embodiment of the spinning wing decoy is the ability for the system to create substantial motion and, sometimes flashing, while not creating substantial noise. To accomplish this, embodiments of this system include sound dampening means which may include at least one or more of the following: a substantially enclosed motor, a motor housing enclosing said motor and further comprising one or more stabilizing recesses to keep the contents of the motor housing in place, a substantially enclosed bearing, a bearing housing with one or more bearing guides to reduce vibrations from the bearing, and/or a bearing house lid with one or more stabilizing recesses to reduce vibrations from the bearing. As a result of the dampening means, the spinning wing decoy can operate at relatively high RPM (e.g., over 100 RPM. 200 RPM, 300 RPM, 350 RPM, or greater), while expelling minimum sound into the surrounding area. For example, the mechanical noise of the components housed in the main control box and of the components housed in the bearing housing are muted by the dampening means. The sound may be below 60 dB and preferably would be below 50 dB if not less. Additional sound will be generated by the wind movement expelled by the rotating wing member. The noise of the overall unit, inclusive of mechanical noise and noise from the wind generated by the motion of the blade, should remain below 80 Db, and it is preferably below 70 Db and even lower than 60 Db. In a preferred embodiment, noise of the overall unit during operation may be below 80 db, 70 Db, 60 Db, or even below 50 Db.

The spinning wing decoy can include rotating and/or up and down flapping of the wings at a rotations per minute (RPM) that varies widely. For example, the spinning wing decoy can include rotating and/or up and down flapping of the wings at a rotations per minute from a low of about 200 RPM, about 300 RPM, about 325 RPM, or about 350 RPM, to a high of about 400 RPM, about 425 RPM, or about 450 RPM. For example, the spinning wing decoy can include rotating and/or up and down flapping of the wings at a rotations per minute from about 200 RPM to 450 RPM, 300 RPM to 450 RPM, about 315 RPM to 360 RPM, about 330 RPM to 400 RPM, about 350 RPM to 425 RPM, or about 400 RPM to 450 RPM.

The electric motor can include a horsepower that varies widely. For example, the electric motor can include a horsepower from a low of about 0.01 hp, about 0.02 hp, or about 0.03 hp, to a high of about 1 hp, about 2 hp, or about 5 hp. For example, the electric motor can include a horsepower from about 0.01 hp to about 5 hp, about 0.01 hp to about 0.1 hp, about 0.02 hp to about 1 hp, about 0.01 hp to about 0.05 hp, or about 0.2 hp to about 0.5 hp.

The one or more electric motor housings can include a length, height, width, thickness, radius, first end, front side, second end, back side, right side, left side, top side, bottom side, outer surface, inner surface, and interior space. In an embodiment, the one or more electric motor housing units can be attached to and/or integrally formed with the battery housings. In an embodiment, the one or more electric motor housing units can be separate from the one or more battery housings. In another embodiment, the electric motor housing units can be inserted into the internal space of the spinning wing decoy through the removable door in the rear of the spinning wing decoy. In another embodiment, the housing unit can be inserted into the internal space of the spinning wing decoy by removing the tail section of the spinning wing decoy.

The electric motor housing can include a length that varies widely. For example, the electric motor housing can include a length from a short of about 0.1 cm, about 1.0 cm, or 2.0 cm, to a long of about 8.0 cm, about 10.0 cm, or about 20.0 cm. In another example, the electric motor housing can include a length from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The electric motor housing can include a width that varies widely. For example, the electric motor housing can include a width from a short of about 0.1 cm, about 1.0 cm, or 2.0 cm, to a long of about 8.0 cm, about 10.0 cm, or about 20.0 cm. In another example, the electric motor housing can include a width from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The electric motor housing can include a height that varies widely. For example, the electric motor housing can include a height from a short of about 0.1 cm, about 1.0 cm, or 2.0 cm, to a long of about 8.0 cm, about 10.0 cm, or about 20.0 cm. In another example, the electric motor housing can include a height from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The one or more battery housings can include a length, height, width, thickness, radius, first end, front side, second end, back side, right side, left side, top side, bottom side, outer surface, inner surface, and interior space. In an embodiment, the battery housing can be attached to and/or integrally formed with the one or more electric motor housing. In an embodiment, the battery housing 206 can be separate from the one or more electric motor housing.

The battery housing can include a length that varies widely. For example, the battery housing can include a length from a short of about 0.1 cm, about 1.0 cm, or 2.0 cm, to a long of about 8.0 cm, about 10.0 cm, or about 20.0 cm. In another example, the battery housing can include a length from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The battery housing can include a width that varies widely. For example, the battery housing can include a width from a short of about 0.1 cm, about 1.0 cm, or 2.0 cm, to a long of about 8.0 cm, about 10.0 cm, or about 20.0 cm. In another example, the battery housing can include a width from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The battery housing can include a height that varies widely. For example, the battery housing can include a height from a short of about 0.1 cm, about 1.0 cm, or 2.0 cm, to a long of about 8.0 cm, about 10.0 cm, or about 20.0 cm. In another example, the battery housing can include a height from about 0.1 cm to about 20.0 cm, about 0.5 cm to about 5.0 cm, about 2.5 cm to about 12.0 cm, about 3.0 cm to about 8.0 cm, about 5.0 cm to about 17.0 cm, or about 6.5 cm to about 9.0 cm.

The one or more remote controllers can used to control the electric motor. In an embodiment, the remote controllers can be electronically coupled to the battery for recharging. The remote controller housing can include a length, height, width, thickness, radius, first end, front side, second end, back side, right side, left side, top side, bottom side, outer surface, inner surface, and interior space. In an embodiment, the remote controller housing can be attached to and/or integrally formed with the one or more battery housings. In an embodiment, the remote controller housing can be separate from the one or more battery housings.

The one or more batteries can include, but are not limited to: a lithium ion battery and rechargeable battery. The battery can include a lithium-ion battery. The battery can include a rechargeable battery. The battery can include a voltage that varies widely. For example, the battery can have a voltage of about 1.5 V (volts), about 3 V, about 6 V, about 6.4 V, about 9 V, or about 12 V.

The one or more drive shaft can include a length, height, width, thickness, radius, first end, front side, second end, back side, right side, left side, top side, bottom side, outer surface, inner surface, and interior space. The drive shaft can include a length that varies widely. For example, the drive shaft can have a length from a short of about 1.0 cm, about 2.0 cm, or about 5.0 cm, to a long of about 10.0 cm, about 15.0 cm, or about 25.0 cm. In another example, the axle can have a length from about 1.0 cm to about 25.0 cm, about 5.0 cm to about 10.0 cm, or about 6.0 cm to about 12.0 cm.

The drive shaft can include a radius that varies widely. For example, the drive shaft can have a radius from a short of about 0.1 cm, about 0.5 cm, or about 1.0 cm, to a long of about 2.0 cm, about 5.0 cm, or about 10.0 cm. In another example, the drive shaft can have a length from about 0.1 cm to about 10.0 cm, about 0.2 cm to about 1.5 cm, or about 0.6 cm to about 4.0 cm.

The one or more axles can include a length, height, width, thickness, radius, first end, front side, second end, back side, right side, left side, top side, bottom side, outer surface, inner surface, and interior space. The axle can include a length that varies widely. For example, the axles can have a length from a short of about 1.0 cm, about 2.0 cm, or about 5.0 cm, to a long of about 10.0 cm, about 15.0 cm, or about 25.0 cm. In another example, the axle can have a length from about 1 cm to about 25.0 cm, about 5.0 cm to about 10.0 cm, or about 6.0 cm to about 12.0 cm.

The axle can include a radius that varies widely. For example, the axle can have a radius from a short of about 0.1 cm, about 0.5 cm, or about 1.0 cm, to a long of about 2.0 cm, about 5.0 cm, or about 10.0 cm. In another example, the drive shafts can have a length from about 0.1 cm to about 10.0 cm, about 0.2 cm to about 1.5 cm, or about 0.6 cm to about 4.0 cm.

The one or more switches can be in electronic communication with the electric motor. In an embodiment, the switch can turn electric motor on and off. In another embodiment, the electric motor can be optionally and directly connected to the removable battery using a wire. This direct connection from electric motor to the removable battery can provide the user with the ability to operate the electric motor in the event that other electrical components fail, such as switches, timers, PC boards, and the like.

In an embodiment, the spinning wing decoy can include a receiver and transmitter that can allow the electric motor to be operated with a remote controller. In an embodiment, the receiver can be positioned in the inner space of the housing. In an embodiment, the remote controller can include an electric programmable device that is capable of controlling the movement of the decoy wings by the user. In an embodiment, the remote controller can be stored in the battery housing. In an embodiment, the remote controller can include a rechargeable battery. In an embodiment, the rechargeable battery of the remote controller can be recharged by connecting to the power unit. In an embodiment, the power unit can include USB connectors, DIN connectors, barrel connectors, 6.35 mm connectors, 3.5 mm connectors, 2.5 mm connectors, RCA connectors, HDMI connectors, molex connectors, IEC connectors, JST connectors, and the like.

One of ordinary skill in the art will readily appreciate that alternative but functionally equivalent components, materials, designs, and equipment can be used. The inclusion of additional elements can be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present invention is intended to embrace all such alternatives, modifications, and variations as fall within the scope of the claims, together with all equivalents thereof.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components illustrated above should not be understood as requiring such separation, and it should be understood that the described program components and systems can generally be integrated together in a single software product or packaged into multiple software products.

All patents, patent applications, provisional applications, and publications referred to or cited herein are incorporated by reference in their entirety, including all figures and tables, to the extent they are not inconsistent with the explicit teachings of this specification.

What is claimed is:

1. A spinning wing decoy comprising:
a frame configured to support a motor housing and a wing member,
wherein a motor is located substantially inside the motor housing;
wherein the wing member is axially connected to the frame and operationally connected to the motor;
wherein the motor is configured to rotate the wing member along the axis;
at least one bearing housing
at least one bearing housing lid; and
at least one bearing;
wherein said decoy is configured to operate such that the wing member rotates at least 200 RPM while emitting less than 80 Db of mechanical noise to the ambient environment.

2. The spinning wing decoy of claim 1, wherein the motor housing is configured to operate such that the wing member rotates at 350 RPM or more while emitting less than 80 Db of mechanical noise to the ambient environment.

3. The spinning wing decoy of claim 1, wherein the motor housing is configured to operate such that the wing member rotates at 350 RPM or more while emitting less than 70 Db of mechanical noise to the ambient environment.

4. The spinning wing decoy of claim 1, wherein the motor housing is configured to substantially dampen the sound such that the motor in operation causes less than 55 Db of mechanical noise to escape the motor housing.

5. The spinning wing decoy of claim 1 wherein the axel may further comprise one or more recesses to facilitate attachment of the one or more wings via one or more pins, one or more screws, one or more clips, or one or more pegs.

6. The spinning wing decoy of claim 1, wherein the motor housing further comprises a retainer ring that provides as a seat for the axle and prevents the axle from being rotated on the bearing end before the wing member is detached from the motor shaft when changing the wing member.

7. The spinning wing decoy of claim 1, wherein the motor housing further comprises a main control box to which a motor door is attached via noise-reducing pegs which pegs reduce vibrations between the main control box and the motor door when the motor is in operation.

8. The spinning wing decoy of claim 7, wherein the motor door further comprises a recesses to receive the axel and which recess reduces vibrations caused by the rotation of the axel.

9. The spinning wing decoy of claim 1, wherein the bearing housing is configured to substantially dampen the sound such that the device in operation causes less than 60 Db of mechanical noise to be generated.

10. The spinning wing decoy of claim 1 wherein the bearing housing further comprises a vibration-reducing mounting tube allowing installation of the bearing housing on the frame such that noise is minimized during operation of the decoy, a bottom hinge, and a bottom catch.

11. The spinning wing decoy of claim 1 wherein the bearing housing further comprises one or more noise reducing bearing guides which minimize vibrations and transverse motion of the bearing during operation.

12. The spinning wing decoy of claim 1 wherein the bearing housing lid further comprises one or more noise-reducing recesses to reduce vibrations and transverse motion of the bearing during operation, a top hinge, and a catch.

13. The spinning wing decoy of claim 1 wherein the bearing is comprised of a noise reducing material.

14. The spinning wing decoy of claim 1 wherein the bearing is comprised of rubber, metal, plastic, ceramic, composite, or a combination of the foregoing materials.
